(19) United States
(12) Patent Application Publication
(10) Pub. No.: US 2012/0283888 A1
(43) Pub. Date: Nov. 8, 2012

(54) Seamless Transition Method and Apparatus for Micro-grid Connect/Disconnect from Grid

(75) Inventors: Jianrong Mao, Beijing (CN); Hongwei Ma, Beijing (CN)

(73) Assignees: State Grid Corporation of China (SGCC), Beijing (CN); China Electric Power Equipment and Technology Co. Ltd., Beijing (CN)

(21) Appl. No.: 13/464,709

(22) Filed: May 4, 2012

(30) Foreign Application Priority Data
May 5, 2011 (CN) 201110115437.6

(51) Int. Cl. G06F 1/26

(52) U.S. Cl. 700/291; 700/286; 700/295

(57) ABSTRACT

A central controller of a micro-grid system is configured to receive the operational parameters of the main grid system and the micro-grid system, update a power generation plan of the micro-grid system based upon the operational parameters of the micro-grid system, wherein the power generation plan is formulated such that power outputs of the micro-grid system approximately match loads of the micro-grid system. Furthermore, the central controller forwards the power generation plan to the plurality of local controllers coupled to the micro-grid system so that the micro-grid system is able to have a seamless transition from a grid-connected mode to a grid-disconnected mode.

This application claims priority to Chinese Application No. 201110115437.6, filed on May 5, 2011, which is incorporated herein by reference in its entirety.

### BACKGROUND

A micro-grid system is a discrete power system including a variety of interconnected power generators, energy storage units and loads. In comparison with a main power utility grid, a micro-grid system is of a clearly defined zone. In addition, the micro-grid system functions a single entity. In response to the needs of its loads, the micro-grid system is capable of connecting to the main power utility grid. The grid connected operation of a micro-grid system is alternatively referred to as a grid connected mode. On the other hand, in response to the system needs or abnormal operation conditions such as power outages at the main power utility grid, the micro-grid system is capable of disconnecting from the main power utility grid. The grid disconnected operation is commonly known as an islanded mode.

The micro-grid system may comprise a plurality of power generators, which could utilize different technologies such as solar energy sources (e.g., solar panels), wind generators (e.g., wind turbines), combined heat and power (CHP) systems, marine energy, geothermal, biomass, fuel cells, micro-turbines and the like. Due to the nature of renewable energy, in order to provide reliable and stable power to critical loads, the micro-grid system may include a plurality of power storage units such as utility-scale energy storage systems, batteries and the like. The power generators, energy storage systems and loads are interconnected each other to be collectively treated by the main grid as a controllable micro grid.

The micro-grid system may be coupled to a main grid through switches such as circuit breakers. The micro-grid system may further comprise a plurality of controllers. The controllers comprising hardware and software systems may be employed to control and manage the micro-grid system. Furthermore, at least one controller is able to control the on and off state of the circuit breakers so that the micro-grid system can be connected to or disconnected from the main grid accordingly.

The micro-grid system has a variety of advantages. Micro-grid systems can improve energy efficiency and reduce power losses by locating power sources close to their loads. In addition, micro-grid systems may improve service quality and reliability. Lastly, micro-grid systems may reduce greenhouse gases and pollutant emissions.

### SUMMARY OF THE INVENTION

These and other problems are generally solved or circumvented, and technical advantages are generally achieved, by preferred embodiments of the present invention which provide an apparatus and method for allowing a micro-grid system to have a seamless transition from a grid-connected mode to a grid-disconnected mode.

In accordance with an embodiment, an apparatus comprises a central controller coupled to a plurality of local controllers, wherein the local controllers configured to detect operational parameters of a main grid system and a micro-grid system, and wherein the central controller is configured to receive the operational parameters of the main grid system and the micro-grid system, update a power generation plan of the micro-grid system based upon the operational parameters of the micro-grid system, wherein the power generation plan is formulated such that power outputs of the micro-grid system approximately match loads of the micro-grid system and forward the power generation plan to the plurality of local controllers coupled to the micro-grid system.

In accordance with another embodiment, a system comprises a plurality of local controllers sampling operational parameters of a micro-grid system and a main grid system, to which the micro-grid system is coupled, a plurality of input and output devices communicably coupled to the local controllers, wherein the input and output devices detect operation status of the micro-grid system and executes control commands and a central controller communicably coupled to the local controllers and the input and output devices.

The central controller is configured to receive the operational parameters of the main grid system and the micro-grid system, update a power generation plan of the micro-grid system based upon the operational parameters of the micro-grid system, wherein the power generation plan is formulated such that power outputs of the micro-grid system approximately match loads of the micro-grid system and forward the power generation plan to the plurality of local controllers coupled to the micro-grid system.

In accordance with yet another embodiment, a method comprises receiving a plurality of electrical variables detected from a micro-grid system coupled to a main grid system, calculating a supply and demand balance of the micro-grid system, generating a new power generation plan based upon the supply and demand balance for a seamless transition from a grid-connected operation mode to a grid-disconnected operation mode and forwarding the new power generation plan to a plurality of local controllers.

An advantage of an embodiment of the present invention is that during a transition from a grid-connected mode to a grid-disconnected mode, the power shortfall or power surplus can be avoided by formulating a new power generation plan based upon read-time detection of the system operational parameters of the micro-grid system and the main grid system. Furthermore, the new power generation plan helps to maintain a balance between the supply of the power generators and the demand of the loads when the micro-grid system moves from a grid-connected mode to an islanded mode. As a result, the quality and reliability of the micro-grid system as well as the main grid system can be improved.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a simplified circuit diagram of a power utility system in accordance with an embodiment;

FIG. 2 illustrates a simplified circuit diagram of a power utility system in accordance with another embodiment;

FIG. 3 a block diagram of the control system of a micro-grid system in accordance with an embodiment;

FIG. 4 illustrates a flowchart of formulating a power generation plan for a micro-grid operating in grid-connected mode in accordance with an embodiment;

FIG. 5 illustrates a flowchart of managing a micro-grid from a grid-connected mode to an islanded mode in accordance with an embodiment;

FIG. 6 illustrates a flowchart of formulating a power generation plan under a power shortfall condition in accordance with an embodiment; and

FIG. 7 illustrates a flowchart of formulating a power generation plan under a power surplus condition in accordance with an embodiment.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the present embodiments are discussed in detail below. It should be appreciated, however, that the present disclosure provides many applicable inventive concepts that can be embodied in a wide variety of specific contexts. The specific embodiments discussed are merely illustrative of specific ways to make and use the embodiments of the disclosure, and do not limit the scope of the disclosure.

The present disclosure will be described with respect to embodiments in a specific context, a controller for seamlessly disconnecting a micro-grid system from a main power utility grid. The embodiments of the disclosure may also be applied, however, to a variety of power utility systems. Hereinafter, various embodiments will be explained in detail with reference to the accompanying drawings.

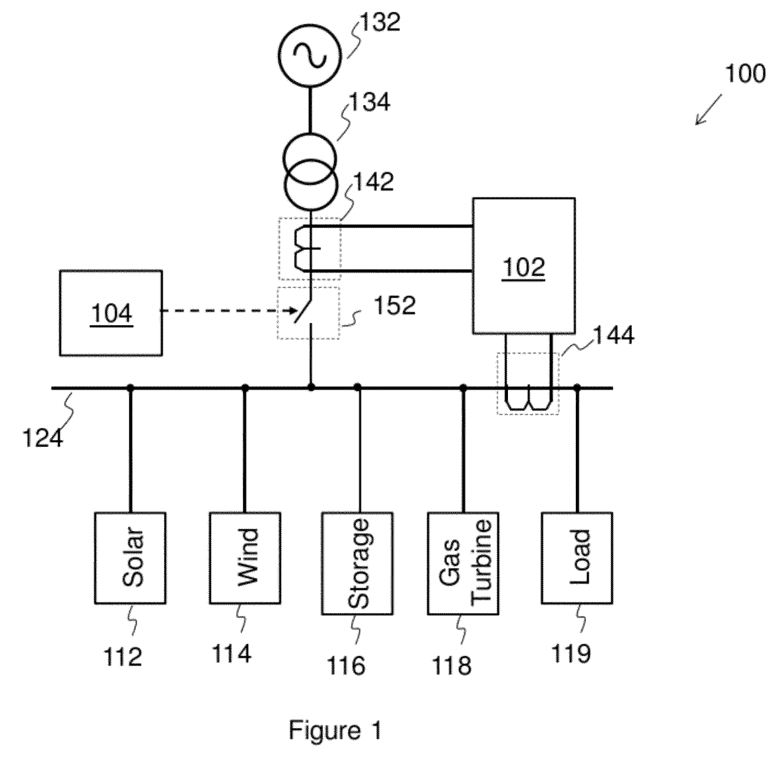

FIG. 1 illustrates a simplified circuit diagram of a power utility system in accordance with an embodiment. The power utility system 100 comprises a main grid system and a micro-grid system. The main grid system may comprise a plurality of power generators, transmission lines and loads (not shown respectively). In order to clearly illustrate the inventive aspects of various embodiments, a power source 132 is used to represent the main grid system, especially the bus, to which the micro-grid system is coupled. In accordance with an embodiment, the main grid bus voltage represented by the power source 132 is about 22 kV. A power transformer 134 is used to convert the main grid bus voltage down to a lower alternating current (ac) voltage such as 380V.

As shown in FIG. 1, the micro-grid system may comprise a plurality of distributed power generators such as a solar power generator 112, a wind power generator 114 and a gas turbine system 118. It should be noted while FIG. 1 illustrates the distributed power generators, the micro-grid system may comprise an interface system (not shown) between the distributed power generators and a local bus 124. In accordance with an embodiment, the interface system may comprise a power inverter and a power regulator connected in series. The power inverter and the power regulator help to transform direct current power generated by the distributed power generators into a regulated alternating current power.

The power generators of the micro-grid system can be divided into two categories, namely non-renewable power generators (e.g., gas turbines) and renewable power generators (e.g., solar panels and wind turbines). In addition, depending on the electrical characteristics of power generators, the power generators of the micro-grid system can be divided into two types. The first type includes power generators having traditional rotating parts such as turbines. According to an embodiment, the first type of power generators may change their power outputs in response to the variations of the system operational parameters. For example, when some system parameters such as voltage, frequency and the like deviate from their normal values during a transition from a grid-connected mode to a grid-disconnected mode, the first type of power generators may automatically change their outputs so as to maintain the stability of the micro-grid system.

On the other hand, the second type of power generators may comprise an inverter coupled between the power generators and the power bus to which they are coupled. As a result, the outputs of this type of power generators may be insensitive to the variations of the system parameters.

As shown in FIG. 1, the micro-grid system may further comprise an energy storage unit 116 and a variety of loads 119. In accordance with an embodiment, the power generators (e.g., solar power generator 112), the energy storage unit 116 and the loads 119 are coupled to the local bus 124. Furthermore, as shown in FIG. 1, there may be a switch 152 coupled between the local bus 124 and the main grid system. In accordance with an embodiment, the switch 152 can be implemented by using suitable devices such as circuit breakers, contactors, thyristors and the like.

In accordance with an embodiment, the loads 119 of the micro-grid system can be divided into three categories, namely regular loads, subcritical loads and critical loads. Throughout the description, the regular loads of the micro-grid system may be alternatively referred to as a first level loads. Likewise, the subcritical loads of the micro-grid system may be alternatively referred to as a second level loads and the critical loads of the micro-grid system may be alternatively referred to as a third level loads.

A local controller 102 is coupled to both the main grid system as well as the micro-grid system. As shown in FIG. 1, there may be a first sensor 142 coupled between the main grid system and the local controller 102. It should be noted while FIG. 1 shows the first sensor 142 is a single entity, the first sensor 142 may comprise various instrument transformers such as current transformers (CTs), potential transforms (PTs) and the like.

Likewise, there may be a second sensor 144 coupled between the micro-grid system and the local controller 102. The structure of the second sensor 144 may be similar to the structure of the first sensor 142, and hence is not discussed in further detail. Through the sensors 142 and 144, the local controller 102 may obtain the operational parameters of the main grid system and the micro-grid system.

An input and output unit 104 is coupled to the switch 152. In accordance with an embodiment, the input and output unit 104 may include an input module and an output module (not shown respectively). The input module is capable of detecting the status of the switch 152 through a plurality of sensors (not shown). The input module not only detects the on and off state of the switch 152, but also obtains other relevant information for controlling the switch 152. For example, a spring loaded device (not shown) is an auxiliary device for turning on/off the switch 152. The input module is capable of detecting the energy level of the spring loaded device and controlling the switch 152 through the spring loaded device.

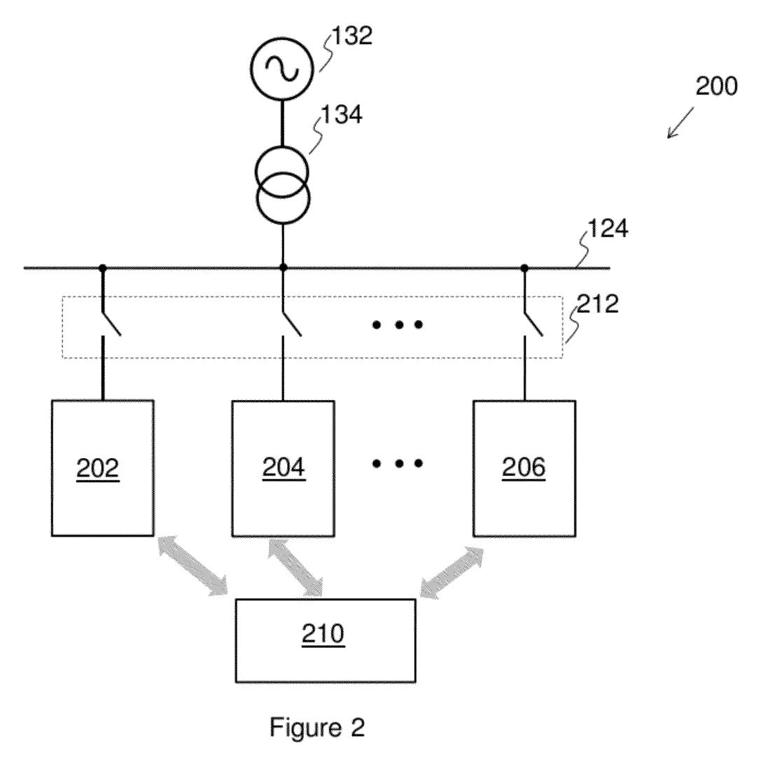

The output module is employed to convert the control command from a central controller (not shown but illustrated in FIG. 2) to a control signal fed to a driver coupled to the switch 152. Such a control signal is configured such that the switch 152 is turned off when the control signal is in a first logic state and the switch 152 is turned on when the control signal is in a second logic state.

FIG. 2 illustrates a simplified circuit diagram of a power utility system in accordance with another embodiment. In the power utility system 200, there may be a plurality of micro-grid systems such as micro-grids 202, 204 and 206. The micro-grids are coupled to the bus 124 of the main grid through their respective switches 212. A central controller 210 may be shared by the plurality of micro-grid systems. In other words, the central controller 210 controls the on and off state of the plurality of switches 212. As a result, each micro-grid system may operates in an islanded mode or a grid-connected mode depending on the on and off state of its switch coupled to the bus 124.

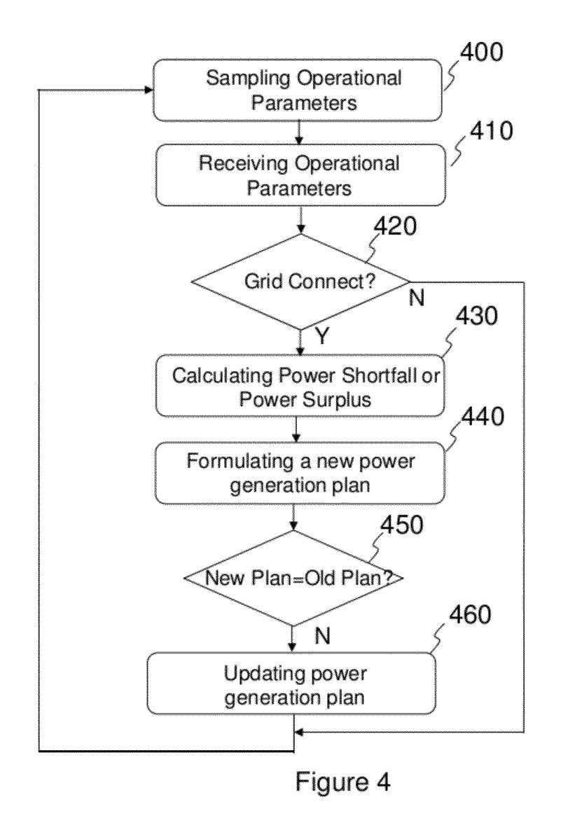

Each micro-grid (e.g., micro-grid 202) may comprise a local controller and an input and output unit. The operation principles of the local controller and the input and output unit have been described above with respect to FIG. 1, and hence are not discussed in further detail herein. The central controller 210 is employed to coordinate the demand of the loads and the supply of the power generators so as to achieve a balance between power demand and power supply. The detailed operation principle of the central controller 210 in FIG. 2 will be described below with respect to FIGS. 4-7. One advantageous feature of having a central controller 210 coordinating a plurality of micro-grid systems is that the central controller 210 is able to seamlessly disconnect a micro-grid system during a transition from a grid-connected mode to an islanded mode. As a result, the power quality and reliability of other micro-grids tied to the bus 124 can be maintained.

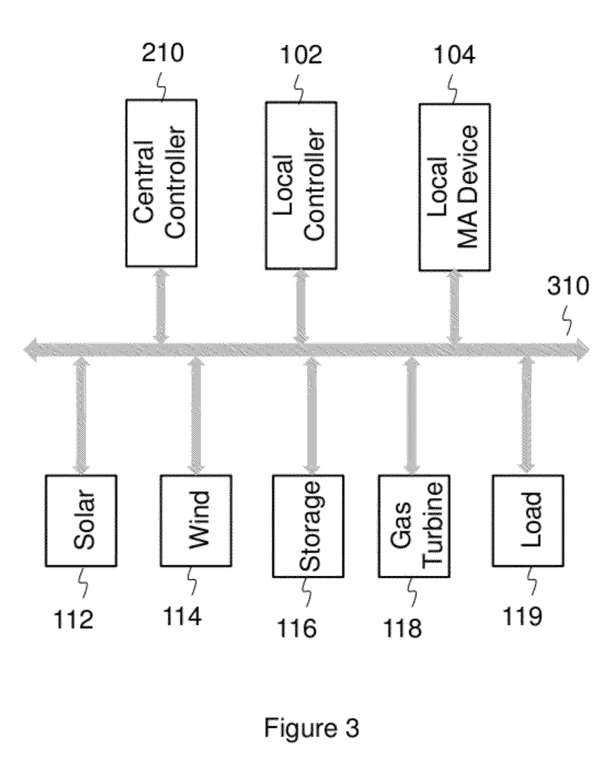

FIG. 3 illustrates a block diagram of the control system of a micro-grid system in accordance with an embodiment. As shown in FIG. 3, in a micro-grid system, all elements of the micro-grid system are interconnected through a plurality of communication channels. As a result, each element (e.g., central controller 210) is able to send/receive data to/from another element (e.g., local controller 102). The data transferred between two elements of the micro-grid system may comply with suitable communication protocols such as Ethernet. The channels 310 between different elements of the micro-grid system are commonly known as an Ethernet network.

FIG. 4 illustrates a flowchart of formulating a power generation plan for a micro-grid operating in grid-connected mode in accordance with an embodiment. At step 400, various local controllers detect operational parameters of their corresponding regions of the micro-grid system. The operational parameters may include voltage, current and the like. The operational parameters can be obtained through suitable detecting equipment such as potential transformers, current transformers and the like.

Furthermore, depending on the system complexity and sampling accuracy requirements, the sampling time may vary. In accordance with an embodiment, the sampling time is approximately equal to 10 seconds. It should be noted that the sampling time is not fixed. Instead, the sampling time including a delay period for waiting sampling results may be adjusted on the fly through an interface unit of the central controller.

At step 410, the central controller receives operational parameters from different local controllers located in the micro-grid system. At step 420, based upon the operational parameters, the central controller first determines whether the micro-grid system operates in grid-connected mode. If the micro-grid system operates in grid-disconnected mode, the central controller bypasses the following steps and proceeds with step 400 again. On the other hand, if the micro-grid system operates in grid-connected mode, the central controller proceeds with step 430.

At step 430, the central controller calculates and determines whether the micro-grid system operates in power shortfall or power surplus based upon the operational parameters received at step 410. In particular, when there is a net power flow from the main grid to the micro-grid system, the potential power shortfall of the micro-grid system can be calculated as follows:

$${P}_{qe} = {P}_{PCC} - {\sum }_{i} ( {P}_{i\_max} - {P}_{i\_cur} )$$

where P_{qe} is the power shortfall of the micro-gird system; P_{PCC} is the power exchange at the connection point between the micro-grid system and the main grid system; Pᵢ_{_{—}}ₘₐₓ is the i^{th} distributed power generator's maximum power output and Pᵢ_{_{—}}_{cur} is the i^{th} distributed power generator's current power output.

On the other hand, when there is a net power flow from the main grid to the micro-grid system, the power surplus after disconnecting the micro-grid system from the main grid can be calculated as follows:

$${P}_{qe} = {P}_{PCC} + {\sum }_{k} ( {P}_{k\_cur} - {P}_{k\_min} )$$

where P_{qe} is the power surplus of the micro-gird system; P_{PCC} is the power exchange at the connection point between the micro-grid system and the main grid system; Pₖ_{_{—}}ₘᵢₙ is the k^{th} distributed power generator's minimum power output and Pₖ_{_{—}}_{cur} is the k^{th} distributed power generator's current power output. It should be noted that the distributed power generators included in the equation above are power sources, whose outputs may change automatically in response to the variations of system operation parameters. It should further be noted that in the power generation plan described below, a power sources in a micro-grid system may not be included into the power shutdown plan if the output of the power source may automatically change in response to the variation of the system operation parameters.

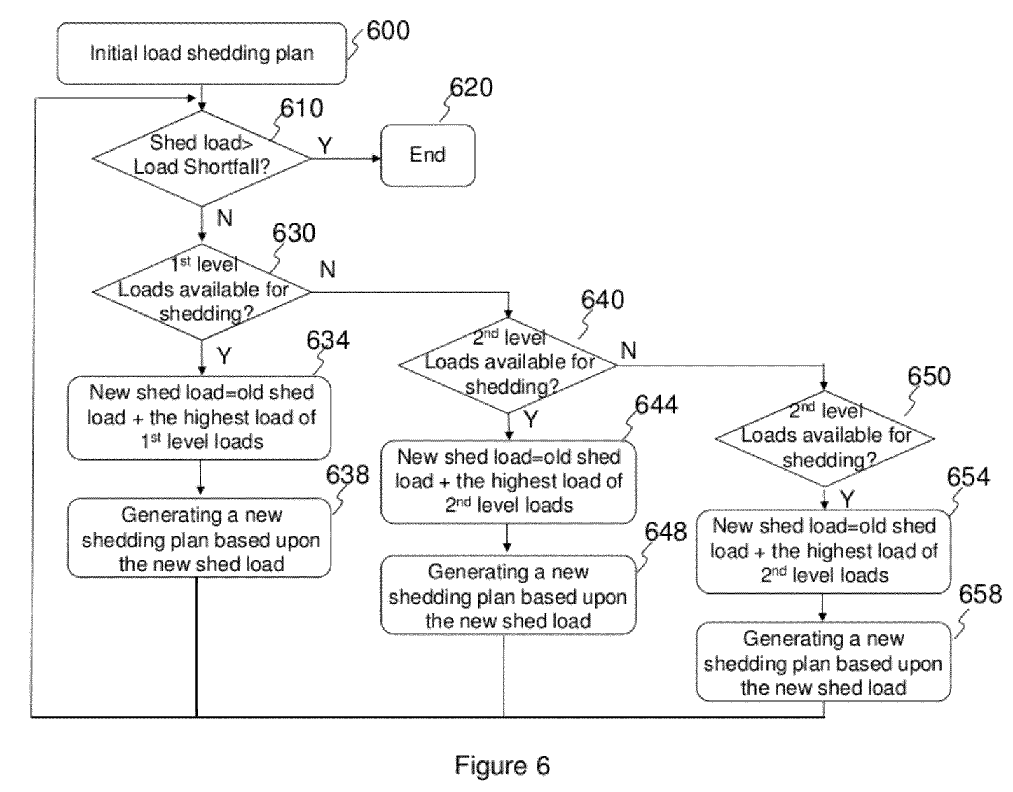

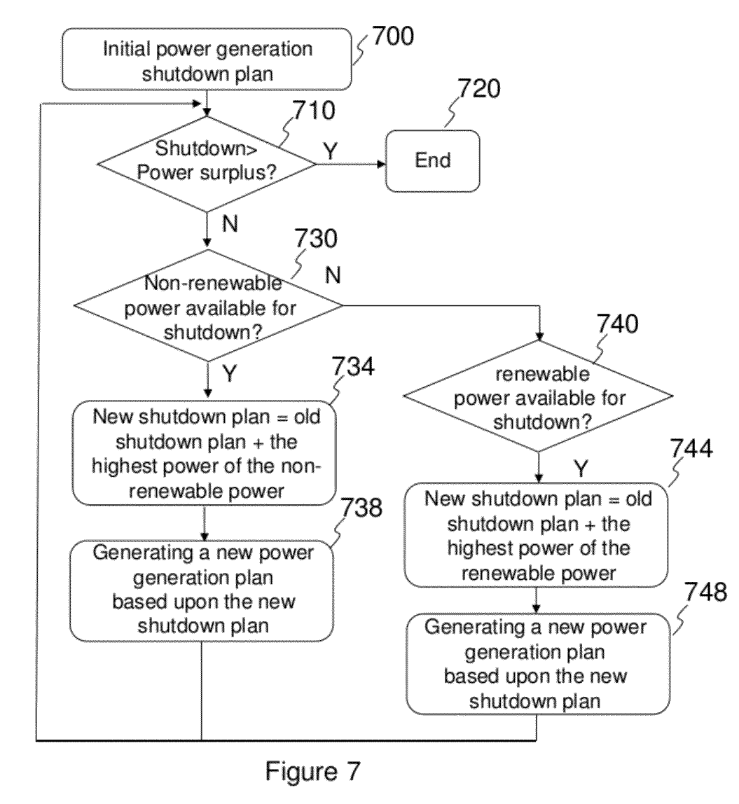

At step 440, based upon P_{qe} calculated at step 430, the central controller formulates a new power generation plan. By employing this new power generation plan, the power shortfall or power surplus of the micro-grid system can be minimized if the micro-grid system is disconnected from the main grid and enters into an islanded operation mode. The detailed principles and processes of formulating a new power generation plan under a power shortfall condition or a power surplus condition will be described below with respect to FIG. 6 and FIG. 7 respectively.

At step 450, the central controller compares the new power generation plan with the existing power generation plan. If the new power generation plan is different from the existing power generation plan, the central controller proceeds with step 460, wherein the central controller sends the new power generation plan to various local controllers. Each local controller updates its power generation plan based upon the new power generation plan accordingly. After that, the central controller returns to step 400.

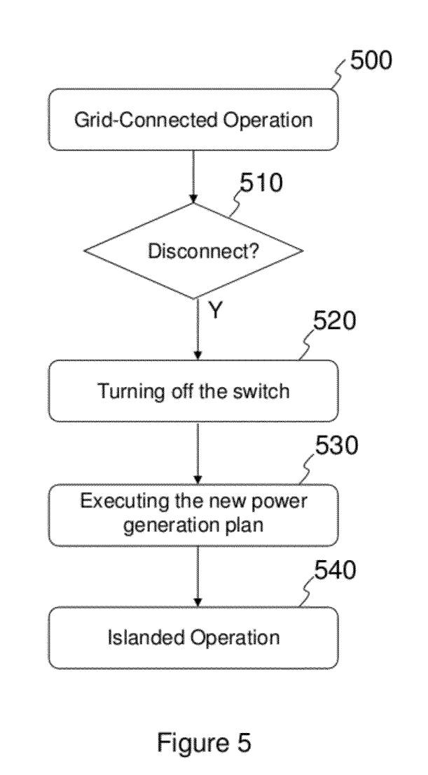

FIG. 5 illustrates a flowchart of managing a micro-grid from a grid-connected mode to an islanded mode in accordance with an embodiment. At step 500, the micro-grid is in grid-connected operation. At step 510, the local controller of the micro-grid keeps detecting the system operational parameters such as voltage, current and the like. The local controller analyzes the voltage and current information. By analyzing the voltage and current information, the local controller may find whether an islanded operation is necessary for the micro-grid system. If the result shows the micro-grid system should enter into an islanded operation mode, the local controller proceeds with step 520, wherein the local controller sends a disconnect signal to a driver coupled to the switch. As a result, the switch coupled between the main grid system and the micro-grid system is turned off.

After the switch is turned off, at the same time, the local controller executes step 530, wherein the newest power generation plan is employed to control the supply of the distributed power generators and the demand of the loads of the micro-grid system. After executing the new power generation plan, at step 540, the power supply and demand of the micro-grid system are balanced and the micro-grid system enters into a stable and reliable islanded operation mode.

It should be noted that the newest power generation plan is based upon real-time detection of system parameters. As described above with respect to FIG. 4, the central controller formulates the newest power generation plan few seconds before the transition from the grid-connected mode to the grid-disconnected mode. Therefore, the newest power generation plan can better reflect the power supply and demand of the micro-grid system.

One advantageous feature of having the newest power generation plan described above is that the power supply and demand of the micro-grid system can be adjusted based upon real-time detection of system operational parameters so that the micro-grid system can achieve a seamless transition from a grid-connected mode to a grid-disconnected mode.

Another advantageous feature of having the newest power generation plan is that the local controllers can detect the islanded operation within a short period. In addition, the local controllers can execute the newest power generation plan immediately after entering into the islanded operation. In accordance with an embodiment, the time for detecting an islanded operation and implementing the newest power generation plan is less than 0.6 seconds. According to the specifications of the power generators and loads of the micro-grid system, unbalanced power supply and demand within a short period may not cause a system failure. As a result, the micro-grid system can achieve a seamless transition from a grid-connected mode to an islanded operation mode.

FIG. 6 illustrates a flowchart of formulating a power generation plan under a power shortfall condition in accordance with an embodiment. At step 600, in consideration with the calculation results at step 430 of FIG. 4, the central controller acknowledges that the micro-grid system operates in a power shortfall condition. Therefore, there is a need of formulating a load shedding plan in order to maintain a seamless transition from a grid-connected mode to an islanded mode. First, the central controller formulates an initial load shedding plan. In accordance with an embodiment, in the initial load shedding plan, the load to be shed is equal to zero.

At step 610, the central controller determines whether the amount of the shed load is greater than the amount of the power shortfall of the micro-grid system. If the shed load is greater than the power shortfall, the central controller proceeds with step 620, wherein the load shedding plan is finalized. On the other hand, if the shed load is not greater than the shortfall, the central controller proceeds with step 630.

At step 630, the central controller determines whether the first level loads of the micro-grid system are available for load shedding. If the first level loads of the micro-grid system are available for load shedding, the central controller proceeds with step 634, wherein the amount of the shed load of the micro-grid system is the sum of the existing shed load and the highest load of the first level loads. In other words, the highest load of the first level loads will be shed. As a result, the highest load of the first level loads is removed from the available loads for load shedding. It should be noted that selecting a highest load for load shedding helps to minimize the impact of load shedding.

After obtaining the new amount of the shed load at step 634, the central controller proceeds with step 638, wherein a new load shedding plan is generated based upon the new amount of the shed load calculated at step 634. After finishing step 638, the central controller returns to step 610 and determines whether the new amount of the shed load is greater than the power shortfall of the micro-grid system. If not, the central controller proceeds with the following steps (e.g., steps 630, 634 and 638) again.

On the other hand, at step 630, if the first level loads are not available for load shedding, the central controller executes step 640. At step 640, the central controller determines whether the second level loads of the micro-grid system are available for load shedding. If the second level loads are available for load shedding, the central controller proceeds with step 644, wherein the amount of the shed load of the micro-grid system is the sum of the existing shed load and the highest load of the second level loads. In other words, the highest load of the second level loads will be shed. As a result, the highest load of the second level loads is removed from the available loads for load shedding.

After obtaining the new amount of the shed load at step 644, the central controller proceeds with step 648, wherein a new load shedding plan is generated based upon the new amount of the shed load calculated at step 644. After finishing step 648, the central controller returns to step 610. If the conditions at step 610 and step 630 cannot be satisfied, the central controller proceeds with the following steps (e.g., steps 640, 644 and 648) again.

At step 640, if the second level loads of the micro-grid system are not available for load shedding, the central controller executes step 650. At step 650, the central controller determines whether the third level loads of the micro-grid system are available for load shedding. If the third level loads are available for load shedding, the central controller proceeds with step 654, wherein the amount of the shed load of the micro-grid system is the sum of the existing shed load and the highest load of the third level loads. In other words, the highest load of the third level loads will be shed. As a result, the highest load of the third level loads is removed from the available loads for load shedding.

After obtaining the new amount of the shed load at step 654, the central controller proceeds with step 658, wherein a new load shedding plan is generated based upon the new amount of the shed load calculated at step 654. After finishing step 658, the central controller returns to step 610. If the conditions at step 610, step 630 and step 640 cannot be satisfied, the central controller proceeds with the following steps (e.g., steps 650, 654 and 658) again.

FIG. 7 illustrates a flowchart of formulating a power generation plan under a power surplus condition in accordance with an embodiment. At step 700, the micro-grid is in grid-connected operation. In consideration with the calculation results at step 430 of FIG. 4, the central controller acknowledges that the micro-grid system is under a power surplus condition. Therefore, there is a need of formulating a power shutdown plan in order to maintain a seamless transition from a grid-connected mode to an islanded mode.

First, the central controller formulates an initial power shutdown plan. In accordance with an embodiment, in the initial plan, the amount of power to be shut down is equal to zero. Referring back to FIG. 1, the power generators can be divided into two types depending on their electrical characteristics. As described above with respect to FIG. 1, the first type is capable of adjusting its output in response to the variations of the system operational parameters. Therefore, the first type of power generators may not be included in the power shutdown plan described below because their outputs can automatically change in response to the power surplus of the micro-grid system.

At step 710, the central controller determines whether the amount of power to be shut down is greater than the amount of the power surplus of the micro-grid system. If the power to be shutdown is equal to or greater than the power surplus of the micro-grid system, the central controller proceeds with step 720, wherein the power shutdown plan is finalized. On the other hand, if the power to be shutdown is not greater than the power surplus, the central controller proceeds with step 730.

At step 730, the central controller determines whether the non-renewable power generators are available for power shutdown. If the non-renewable power generators are available for power shutdown, the central controller proceeds with step 734, wherein the amount of power to be shut down of the micro-grid system is the sum of the existing shut down power and the power from the non-renewable power generator having the highest power output. As a result, the power generator having a highest power output is removed from the available non-renewable power generators for power shutdown. It should be noted that selecting a power generator having the highest power output for power shutdown helps to minimize the impact of power shutdown.

After obtaining the new amount of the shutdown power at step 734, the central controller proceeds with step 738, wherein a new power shutdown plan is generated based upon the new amount of the power to be shut down at step 734. After finishing step 738, the central controller returns to step 710 and determines whether the total power to be shut down can satisfy the power surplus of the micro-grid system. If not, the central controller proceeds with the following steps (e.g., steps 730, 734 and 738) again.

On the other hand, at step 730, if the non-renewable power generators are not available for power shutdown, the central controller executes step 740. At step 740, the central controller determines whether the renewable power generators of the micro-grid system are available for power shutdown. If the renewable power generators are available for power shutdown, the central controller proceeds with step 744, wherein the amount of power to be shut down of the micro-grid system is the sum of the existing shut down power and the power from the renewable power generator having a highest power output. As a result, the renewable power generator having a highest power output is removed from the available renewable power generators for power shutdown.

After obtaining the new amount of the shutdown power at step 744, the central controller proceeds with step 748, wherein a new power shutdown plan is generated based upon the new amount of the power to be shut down at step 744. After finishing step 748, the central controller returns to step 710 and determines whether the total power to be shut down can satisfy the conditions at step 710 and step 730. If not, the central controller proceeds with the following steps (e.g., steps 740, 744 and 748) again.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An apparatus comprising:
a central controller coupled to a plurality of local controllers, wherein the local controllers configured to detect operational parameters of a main grid system and a micro-grid system, and wherein the central controller is configured to:
receive the operational parameters of the main grid system and the micro-grid system;
update a power generation plan of the micro-grid system based upon the operational parameters of the micro-grid system, wherein the power generation plan is formulated such that power outputs of the micro-grid system approximately match loads of the micro-grid system; and
forward the power generation plan to the plurality of local controllers coupled to the micro-grid system.

2. The apparatus of claim 1, further comprising:
a calculation unit, wherein the calculation unit is configured to:
based upon the operational parameters, calculate a power shortfall of the micro-grid system if the micro-grid system is disconnected from the main grid; and
based upon the operational parameters, calculate a power surplus of the micro-grid system if the micro-grid system is disconnected from the main grid.

3. The apparatus of claim 2, wherein under the power shortfall, the central controller formulates the power generation plan by shedding less critical loads first.

4. The apparatus of claim 2, wherein under the power shortfall, the central controller formulates the power generation plan by shedding a highest load first.

5. The apparatus of claim 2, wherein under the power surplus, the central controller formulates the power generation plan by shutting down non-renewable power sources first.

6. The apparatus of claim 2, wherein under the power surplus, the central controller formulates the power generation plan by shutting down a highest power source first.

7. A system comprising:
a plurality of local controllers sampling operational parameters of a micro-grid system and a main grid system, to which the micro-grid system is coupled;
a plurality of input and output devices communicably coupled to the local controllers, wherein the input and output devices detect operation status of the micro-grid system and executes control commands; and
a central controller communicably coupled to the local controllers and the input and output devices, wherein the central controller is configured to:
receive the operational parameters of the main grid system and the micro-grid system;
update a power generation plan of the micro-grid system based upon the operational parameters of the micro-grid system, wherein the power generation plan is formulated such that power outputs of the micro-grid system approximately match loads of the micro-grid system; and
forward the power generation plan to the plurality of local controllers coupled to the micro-grid system.

8. The system of claim 7, further comprising:
a plurality of regular loads;
a plurality of subcritical loads; and
a plurality of critical loads, wherein under a power shortfall condition, regular loads are shed first in the power generation plan for a seamless transition from a grid-connected mode to an islanded mode.

9. The system of claim 8, wherein:
a highest regular load of the regular loads is selected to be shed in the power generation plan if the regular loads are available for load shedding;
a highest subcritical load of the subcritical loads is selected to be shed in the power generation plan if the subcritical loads are available for load shedding; and
a highest critical load of the critical loads is selected to be shed in the power generation plan if the critical loads are available for load shedding.

10. The system of claim 7, further comprising:
a plurality of non-renewable power generators; and
a plurality of renewable power generators, wherein under a power surplus condition, the non-renewable power generators are shut down first in the power generation plan for a seamless transition from a grid-connected mode to an islanded mode.

11. The system of claim 10, wherein:
a non-renewable generator having highest power of the non-renewable power generators is selected to be shut down in the power generation plan if the non-renewable power generators are available for power shutdown; and
a renewable generator having highest power of the renewable power generators is selected to be shut down in the power generation plan if the renewable power generators are available for power shutdown.

12. The system of claim 7, further comprising:
a switch coupled between the micro-grid system and the main grid system, wherein the switch is implemented by a device selected from a group consisting of breakers, contactors, thyristors, and any combination thereof.

13. The system of claim 7, further comprising:
a power source coupled to the micro-grid system, wherein an output of the power source automatically changes in response to operational parameter variations.

14. A method comprising:
receiving a plurality of electrical variables detected from a micro-grid system coupled to a main grid system;
calculating a supply and demand balance of the micro-grid system;
generating a new power generation plan based upon the supply and demand balance for a seamless transition from a grid-connected operation mode to a grid-disconnected operation mode; and
forwarding the new power generation plan to a plurality of local controllers.

15. The method of claim 14, further comprising:
determining whether the micro-grid system operates in a power shortfall state or a power surplus state;
responsive to the determining, adding a power generator into a power shutdown plan if the micro-grid system operates in the power surplus state; and
responsive to the determining, adding a load into a load shedding plan if the micro-grid system operates in the power shortfall state.

16. The method of claim 15, further comprising:
selecting a non-renewable power source having a highest power output from non-renewable power generators as the power generator if the non-renewable power generators are available for power shutdown.

17. The method of claim 16, further comprising:
responsive to unavailable non-renewable power generators, selecting a renewable power source having a highest power output from renewable power generators as the power generator if the renewable power generators are available for power shutdown.

18. The method of claim 15, further comprising:
selecting a regular load having a highest load demand from regular loads of the micro-grid system as the load if the regular loads are available for load shedding.

19. The method of claim 15, further comprising:
responsive to unavailable regular loads for load shedding, selecting a subcritical load having a highest load demand from subcritical loads of the micro-grid system as the load if the subcritical loads are available for load shedding.

20. The method of claim 15, further comprising:
responsive to unavailable regular loads and unavailable subcritical loads for load shedding, selecting a critical load having a highest load demand from critical loads of the micro-grid system as the load if the critical loads are available for load shedding.
